(19) United States
(12) Patent Application Publication
(10) Pub. No.: US 2012/0182618 A1
(43) Pub. Date: Jul. 19, 2012

(54) DIFFRACTION GRATING LENS AND IMAGING DEVICE USING SAME

(75) Inventors: Yuka Okada, Hyogo (JP); Takamasa Ando, Osaka (JP); Tsuguhiro Korenaga, Osaka (JP)

(73) Assignee: PANASONIC CORPORATION, Osaka (JP)

(21) Appl. No.: 13/498,516

(22) PCT Filed: Aug. 11, 2011
(86) PCT No.: PCT/JP2011/004571

§ 371 Date: Mar. 27, 2012

(30) Foreign Application Priority Data
Aug. 19, 2010 (JP) 2010-184360

(51) Int. Cl. G02B 27/44

(52) U.S. Cl. 359/570

(57) ABSTRACT

A diffraction grating lens according to the present invention includes a lens body 171, and a diffraction grating which has been formed on the surface of the lens body 171 and which includes diffraction steps and concentric annular zones. Each annular zone is interposed between two adjacent ones of the diffraction steps. The lens body 171 is made of a first material that has a refractive index n₁ (λ) at an operating wavelength λ. The diffraction grating is in contact with the air. At least one of the annular zones has one of a recess 11 and a protrusion 12 provided for at least a part of the inner end portion thereof and the other provided for at least a part of the outer end portion thereof, respectively. The diffraction grating lens satisfies the relation

$$0.9 d \leq \frac{m \cdot λ}{{n}_{1} ( λ ) - 1} \leq 1.1 d$$

where d represents a designed step length of the diffraction step 14 and m represents an order of diffraction.

### TECHNICAL FIELD

The present invention relates to a diffraction grating lens (or diffractive optical element) that makes incoming light either converge or diverge by utilizing a diffraction phenomenon and also relates to an imaging device that uses such a lens.

### BACKGROUND ART

A diffraction grating lens, of which the surface functions as a diffraction grating, can correct various lens aberrations such as field curvature and chromatic aberration (which is a shift of a focal point according to the wavelength) very well. This is because a diffraction grating has distinct properties, including inverse dispersion and anomalous dispersion, and also has excellent ability to correct the chromatic aberration. If a diffraction grating is used in an imaging optical system, the same performance is realized by using a smaller number of lenses compared to a situation where an imaging optical system is made up of only aspheric lenses. As a result, the manufacturing cost can be cut down, the optical length can be shortened, and the overall size can be reduced.

Hereinafter, a conventional method for designing the shape of a diffraction grating lens will be described with reference to FIGS. 19(a) through 19(c). In the prior art, a diffraction grating lens is designed by either a phase function method or a high refractive index method in most cases. Although a designing process that uses the phase function method will be described as an example, the final result will be the same even if the design process is carried out by the high refractive index method.

The shape of a diffraction grating lens is a combination of the basic shape of a lens body, on which a diffraction grating is to be formed (i.e., the shape of a refractive lens), and the shape of the diffraction grating. For example, FIG. 19(a) illustrates an exemplary situation where the basic shape Sb of a lens body is aspheric and FIG. 19(b) illustrates an exemplary diffraction grating shape Sp1, which is determined by the phase function represented by the following Equations (1):

$$φ ( r ) = \frac{2 π}{{λ}_{0}} ψ ( r ) \\ ψ ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + … + {a}_{i} {r}^{i} \\ ( {r}^{2} = {x}^{2} + {y}^{2} ) \qquad ( 1 )$$

where φ (r) is a phase function represented by the shape Sp in FIG. 19(b), Ψ (r) is an optical path length difference function (z=Ψ(r)), r is a radial distance from the optical axis, λ₀ is a designed wavelength, and a₁, a₂, a₃, a₄, a₅, a₆, . . . and aᵢ are coefficients.

As can be seen from FIG. 19(b), in the diffraction grating that uses first-order diffracted light, a annular zone is arranged every time the phase with respect to a reference point (i.e., the center) increases by 2π in the phase function φ (r). The shape Sbp of the diffraction grating surface shown in FIG. 19(c) is determined by adding the diffraction grating shape Sp that is represented by such a phase function curve that is divided every 2π to the basic shape Sb shown in FIG. 19(a).

In a situation where the diffraction grating shape Sbp shown in FIG. 19(c) is applied to an actual lens body, a diffraction effect can be achieved if the step height 161 of each annular zone satisfies the following Equation (2):

$$d = \frac{m \cdot λ}{{n}_{1} ( λ ) - 1} \qquad ( 2 )$$

where m is a designed order (e.g., m=1 as for first-order diffracted light), λ is the operating wavelength, d is the step height of the diffraction grating, and n₁(λ) is the refractive index of a lens material that makes the lens body at the operating wavelength λ. The refractive index of a lens material has a wavelength dependence and is a function of the wavelength.

In a diffraction grating that satisfies this Equation (2), the phase difference between the root and the end of a annular zone becomes 2π on the phase function, and the optical path difference with respect to light with the operating wavelength λ becomes an integral number of times as long as the wavelength. Consequently, the diffraction efficiency of first-order diffracted light (which will be referred to herein as “first-order diffraction efficiency”) with respect to light with the operating wavelength can be approximately equal to 100%. As the operating wavelength λ varies, the d value at which the diffraction efficiency becomes 100% also varies in accordance with Equation (2). Conversely, if the d value is fixed, the diffraction efficiency can be 100% at no other wavelength but at the operating wavelength λ that satisfies Equation (2).

If a diffraction grating lens is used for general image capturing purposes, light falling within a broad wavelength range (e.g., a visible radiation wavelength range of 400 nm to 700 nm) needs to be diffracted. For that reason, when visible radiation is incident on a diffraction grating lens, which has a diffraction grating 272 on a lens body 171, not only a first-order diffracted light ray 175 that should be produced from a light ray, of which the wavelength has been determined to be the operating wavelength λ, but also other diffracted light rays 176 of unnecessary orders (which will be sometimes referred to herein as “unnecessary order diffracted light rays”) are produced as shown in FIG. 20. For example, if the wavelength that determines the step height d is supposed to be a green ray wavelength (e.g., 540 nm), then the first-order diffraction efficiency becomes 100% and no unnecessary order diffracted light rays 176 are produced at the green ray wavelength. At a red ray wavelength (e.g., 640 nm) or at a blue ray wavelength (e.g., 440 nm), however, the first-order diffraction efficiency does not become 100% and a zero-order diffracted red ray or a second-order diffracted blue ray will be produced as an unnecessary order diffracted light ray 176, which deteriorates the image quality with flares or ghosts or degrades the MTF (modulation transfer function) characteristic. In FIG. 20, only a second-order diffracted light ray is illustrated as the unnecessary order diffracted light ray 176.

Patent Document No. 1 teaches covering the surface of the lens body 171 with the diffraction grating 12 with an optical adjustment layer 181 of an optical material that has a different refractive index and a different refractive index dispersion from the lens body as shown in FIG. 21. According to Patent Document No. 1, by setting the refractive index of the lens body 171 with the diffraction grating 272 and that of the optical adjustment layer 181 that covers the diffraction grating 172 to fall within particular ranges, the wavelength dependence of the diffraction efficiency can be reduced and the flares involved with the unnecessary order diffracted light rays can be eliminated.

Patent Document No. 2 discloses that in order to prevent a light ray that has been reflected from the wall surface of a annular zone from being transmitted through the surface of that annular zone, a light absorbing portion is arranged around the root of the step on the surface of the annular zone. According to Patent Document No. 2, such a structure can prevent the wall reflected flare light from being transmitted through the optical element's surface.

Patent Document No. 3 discloses a method for increasing the diffraction efficiency by shaping the wavefront of a spherical wave light ray, which is going to be transmitted through the surface of an annular zone, into that of a planar wave with a raised portion arranged around the top of a annular zone of a diffraction grating.

### CITATION LIST

### Patent Literature

Patent Document No. 1: Japanese Patent Application Laid-Open Publication No. 09-127321

Patent Document No. 2: Japanese Patent Application Laid-Open Publication No. 2006-162822

Patent Document No. 3: Japanese Patent Application Laid-Open Publication No. 2003-315526

### SUMMARY OF INVENTION

### Technical Problem

As disclosed in Patent Documents Nos. 1 to 3, the flare light, which has raised a problem in the prior art, is produced from either the unnecessary diffracted light due to the wavelength dependence of a first-order diffracted light ray or the light that has been reflected from the wall surface of an annular zone.

Meanwhile, the present inventors discovered that as the annular zone pitch of the diffraction grating of a diffraction grating lens was reduced or when a subject with an extremely high light intensity was captured, stripe flare rays, having a different pattern from the unnecessary order diffracted light rays described above, would be produced. Nobody else should know that such stripe flare rays will be produced in a diffraction grating lens. The present inventors also discovered that such stripe flare rays could debase the quality of an image shot significantly under certain conditions.

It is therefore an object of the present invention to overcome at least one of these problems by providing a diffraction grating lens that can minimize such a degradation in image quality due to those stripe flare rays and an imaging device that uses such a lens.

### Solution to Problem

A diffraction grating lens according to the present invention includes a lens body, and a diffraction grating which has been formed on the surface of the lens body and which includes a plurality of diffraction steps and a plurality of concentric annular zones. Each annular zone is interposed between two adjacent ones of the diffraction steps. The lens body is made of a first material that has a refractive index n₁ (λ) at an operating wavelength λ. The diffraction grating is in contact with the air. Each annular zone includes an intermediate portion and two end portions, between which the intermediate portion is interposed in a radial direction. At least one of the annular zones has a recess and a protrusion provided for at least a part of one of the two end portions thereof and at least a part of the other end portion thereof, respectively. The diffraction grating lens satisfies the relation

$$0.9 d \leq = \frac{m \cdot λ}{{n}_{1} ( λ ) - 1} \leq .11 d$$

where d represents a designed step length of the diffraction step and m represents an order of diffraction.

Another diffraction grating lens according to the present invention includes a lens body, a diffraction grating which has been formed on the surface of the lens body and which includes a plurality of concentric diffraction steps and a plurality of concentric annular zones, each annular zone being interposed between two adjacent ones of the diffraction steps, and an optical adjustment layer, which is provided for the lens body so as to cover the diffraction grating. The lens body is made of a first material that has a refractive index n₁ (λ) at an operating wavelength λ. The optical adjustment layer is made of a second material that has a refractive index n₂ (λ) at the operating wavelength λ. Each annular zone includes an intermediate portion and two end portions, between which the intermediate portion is interposed in a radial direction. At least one of the annular zones has a recess and a protrusion provided for at least a part of one of the two end portions thereof and at least a part of the other end portion thereof, respectively. The diffraction grating lens satisfies the relation

$$0.9 d \leq \frac{m \cdot λ}{{n}_{1} ( λ ) - {n}_{2} ( λ )} \leq 1.1 d$$

where d represents a designed step length of the diffraction step and m represents an order of diffraction.

In one preferred embodiment, at least one of the protrusion and the recess is provided almost all around the at least one annular zone.

In this particular preferred embodiment, when measured perpendicularly to the optical axis of the diffraction grating on a plane that includes that optical axis, the width of the protrusion and the recess is within the range of 5% to 25% of the width of the at least one annular zone.

In a specific preferred embodiment, the height of the protrusion and the recess as measured along the optical axis of the diffraction grating is within the range of 3% to 20% of the designed step length d of the diffraction step.

In a more specific preferred embodiment, the protrusion and the recess are provided for multiple ones of the annular zones.

In an even more specific preferred embodiment, the protrusion and the recess are provided for at least two of the multiple annular zones that are located around the outer periphery of the diffraction grating.

An imaging device according to the present invention includes a diffraction grating lens according to any of the preferred embodiments of the present invention described above, and an image sensor.

### ADVANTAGEOUS EFFECTS OF INVENTION

According to the present invention, one of a recess and a protrusion is provided for the inner end portion of an annular zone and the other is provided for the outer end portion of the annular zone. That is why a location where stripe flare will be produced can be shifted. As a result, on an image shot, part of the stripe flare and an image of the light source can overlap with each other. Or on an image capturing plane, the focus position of a part of the stripe flare can be shifted outward. Consequently, the integral quantity of stripe flare to be produced around the light source can be reduced and the influence of the stripe flare on the image shot can be cut down as well.

### BRIEF DESCRIPTION OF DRAWINGS

FIG. 1 is a cross-sectional view illustrating a preferred embodiment of a diffraction grating lens according to the present invention.

FIG. 2 is a cross-sectional view illustrating a portion of the diffraction grating lens shown in FIG. 1 in the vicinity of its diffraction grating.

FIG. 3 illustrates in what state the wavefront that has been transmitted through an annular zone is in the diffraction grating lens shown in FIG. 1.

FIG. 4 illustrates the shape of stripe flare that has been produced on the image capturing plane of an image sensor from the light that has been transmitted through the diffraction grating lens shown in FIG. 1.

FIG. 5 is a cross-sectional view illustrating a portion of a diffraction grating lens as a variation of the first preferred embodiment in the vicinity of its diffraction grating.

FIG. 6 illustrates in what state the wavefront that has been transmitted through an annular zone is in the embodiment shown in FIG. 5.

FIG. 7 is a cross-sectional view illustrating another variation of the first preferred embodiment.

FIGS. 8(a) through 8(f) illustrate other modified cross-sectional shapes for the diffraction grating of the first preferred embodiment.

FIG. 9 is a cross-sectional view illustrating a second preferred embodiment of a diffraction grating lens according to the present invention.

FIG. 10 is a cross-sectional view illustrating a portion of the diffraction grating lens shown in FIG. 9 in the vicinity of its diffraction grating.

FIGS. 11(a) and 11(b) are respectively a cross-sectional view and a plan view illustrating a preferred embodiment of an optical element according to the present invention, and FIGS. 11(c) and 11(d) are respectively a cross-sectional view and a plan view illustrating another preferred embodiment of an optical element according to the present invention.

FIG. 12 is a cross-sectional view schematically illustrating a preferred embodiment of an imaging device according to the present invention.

Portion (a) of FIG. 13 is a partial plan view illustrating one annular zone of a diffraction grating lens as a first specific example of the present invention when viewed from over the lens and portion (b) of FIG. 13 shows the profile of that annular zone in the height direction.

FIG. 14 shows a two-dimensional image of the light that has been transmitted through the diffraction grating lens as the first specific example of the present invention.

Portion (a) of FIG. 15 is a partial plan view illustrating one annular zone of a diffraction grating lens as a second specific example of the present invention when viewed from over the lens and portion (b) of FIG. 15 shows the profile of that annular zone in the height direction.

FIG. 16 shows a two-dimensional image of the light that has been transmitted through the diffraction grating lens as the second specific example of the present invention.

Portion (a) of FIG. 17 is a partial plan view illustrating one annular zone of a diffraction grating lens as a comparative example when viewed from over the lens and portion (b) of FIG. 17 shows the profile of that annular zone in the height direction.

FIG. 18 shows a two-dimensional image of the light that has been transmitted through the diffraction grating lens as the comparative example.

FIGS. 19(a) through 19(c) illustrate how to determine the diffraction grating surface shape of a conventional diffraction grating lens.

FIG. 20 illustrates how unnecessary diffracted light rays are produced in a conventional diffraction grating lens.

FIG. 21 is a cross-sectional view illustrating a conventional diffraction grating lens with an optical adjustment layer.

FIG. 22 illustrates an annular zone of a diffraction grating as viewed in the optical axis direction.

FIG. 23 illustrates the wavefront of a light ray that has been transmitted through a narrow annular zone.

FIG. 24 illustrates how stripe flare is produced on an image sensor on which a bundle of rays that has been transmitted through an annular zone is condensed.

### DESCRIPTION OF EMBODIMENTS

First of all, the stripe flare to be produced by a diffraction grating lens, which was discovered by present inventors, will be described.

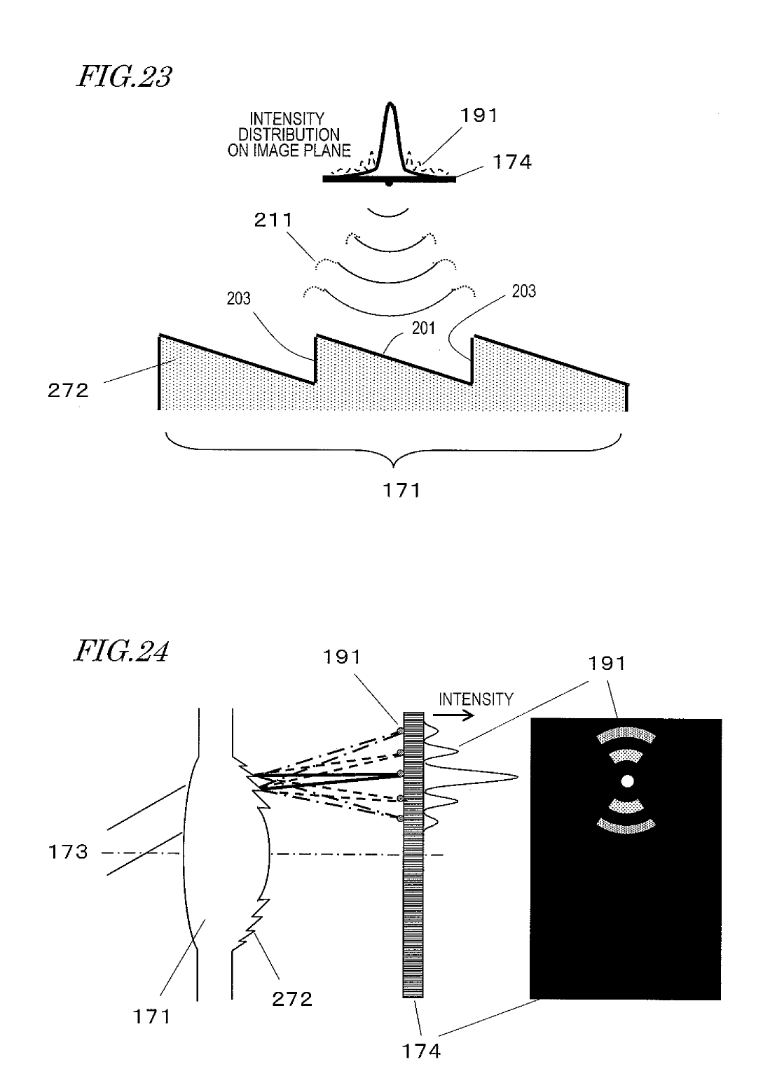

FIG. 22 is a plan view of a diffraction grating as viewed in the optical axis direction. FIG. 23 schematically illustrates a cross section of a diffraction grating and a wavefront phase state of the light that has been transmitted through the diffraction grating. As shown in FIG. 22, the diffraction grating 272 has a number of annular zones, which are arranged to form a concentric pattern. As shown in FIGS. 22 and 23, if attention is paid to one 201 of the multiple annular zones, any two adjacent annular zones are divided from each other by a diffraction step 203 that is arranged between those two annular zones. That is why the light being transmitted through the annular zone 201 is cut off at the position of the diffraction step 203. For that reason, the light being transmitted through each annular zone of the diffraction grating can be regarded as light passing through a slit with an annular zone pitch Λ.

If the annular zone pitch Λ decreases, the light being transmitted through the diffraction grating lens can be regarded as light passing through very narrow slits that are arranged concentrically. As a result, in the vicinity of the diffraction steps 203, a bypassing phenomenon 211 of the wavefront of the light is observed as shown in FIG. 23. And that wavefront bypassing phenomenon 211 is a major factor in the production of the stripe flare 191.

FIG. 24 schematically illustrates how incoming light enters a diffraction grating lens with a diffraction grating obliquely to the optical axis 173 and how its outgoing light gets diffracted by the diffraction grating. Generally speaking, a light ray that has bypassed while passing through a very narrow slit of an opaque portion will form diffraction fringes around the central focus position at a viewpoint at infinity, which is so-called “Fraunhofer diffraction”. If a lens system with a positive focal length is included, such a diffraction phenomenon also arises at a finite distance (i.e., on a focal plane). As a diffraction grating usually has multiple annular zones, each of those annular zones 201 produces such diffraction fringes due to the Fraunhofer diffraction.

The present inventors confirmed, by evaluating images using real lenses, that as the pitch Λ of the annular zones 201 decreased, the light rays transmitted through the respective annular zones 201 would more and more interfere with each other to produce stripe flare 191 with a fan-shaped pattern as shown in FIG. 24. The present inventors also discovered that such stripe flare 191 will be produced significantly if an even greater quantity of light than the incoming light to produce the well-known unnecessary order diffracted light is incident on the imaging optical system and that the unnecessary order diffracted light is not produced at particular wavelengths but the stripe flare 191 is produced in the entire operating wavelength range including the designed wavelength.

Those stripe flare rays 191 spread more broadly on the image than the unnecessary order diffracted light rays, thus debasing the image quality. Particularly in an unusual shooting environment with an extremely high contrast ratio (e.g., when a bright subject such as a light needs to be shot at night, for example), the stripe flare rays 191 would get even more noticeable and cause a problem. On top of that, as the stripe flare rays 191 form a distinct bright and dark striped pattern, the stripe flare rays 191 are much more noticeable on the image shot than the unnecessary order diffracted light rays are.

In order to reduce the influence of such stripe flare rays to be seen on an image shot, the present inventors invented a diffraction grating lens with a novel structure and an imaging device using such a lens. Hereinafter, preferred embodiments of a diffraction grating lens according to the present invention will be described with reference to the accompanying drawings.

### Embodiment 1

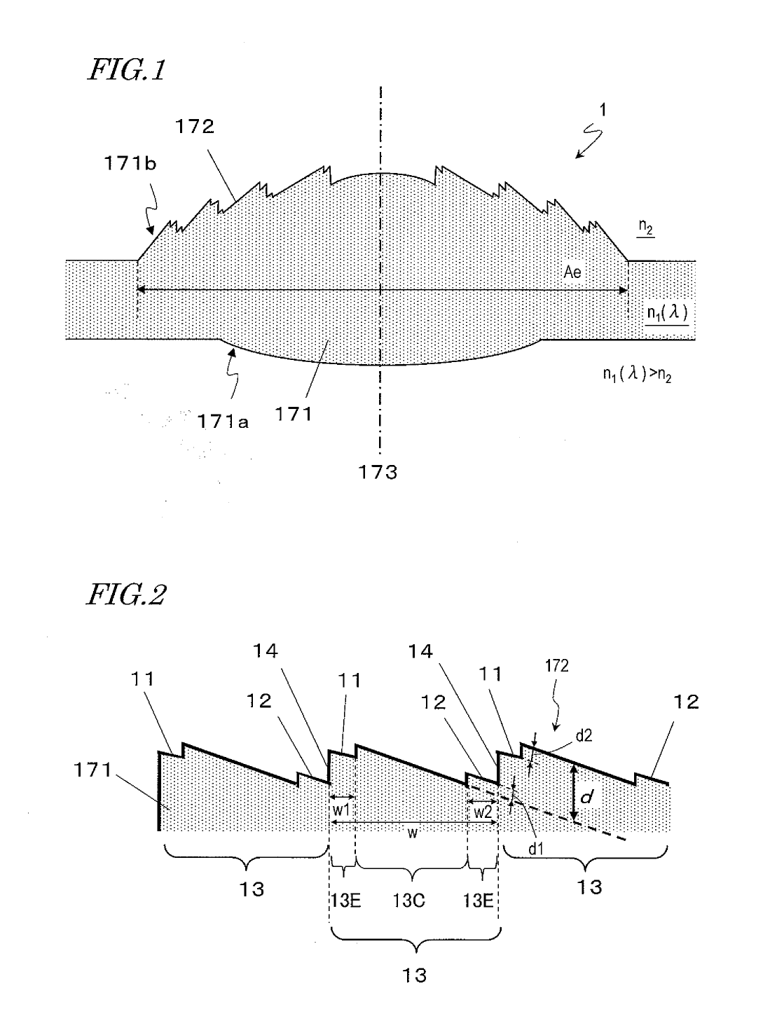

Hereinafter, preferred embodiments of a diffraction grating lens according to the present invention will be described. FIG. 1 is a cross-sectional view illustrating the structure of a diffraction grating lens 1 as a first specific preferred embodiment of the present invention. The diffraction grating lens 1 includes a lens body 171 and a diffraction grating 172 that has been formed on the surface of the lens body 171.

The lens body 171 is made of a first material, of which the refractive index will be represented herein by n₁ (λ), where λ is the operating wavelength of the diffraction grating lens 1. The refractive index of the first material has wavelength dependence and is a function of the wavelength. Also, the diffraction grating 172 is in contact with a medium with a refractive index n₂(λ). In a typical application of the diffraction grating lens 1, the medium is the air and the refractive index n₂ (λ) is one.

The lens body 171 has first and second surfaces 171a and 171b and the second surface 171b has the diffraction grating 172, which is located at least in the effective area Ae of the lens body 171. The effective area Ae refers herein to a portion of the diffraction grating lens 1 that has a light converging or diverging function. Also, if the quantity of light that can enter this diffraction grating lens 1 is limited by a diaphragm, for example, the effective area Ae refers herein to a part of that light converging or diverging portion on which the incoming light enters.

Although the diffraction grating 172 is arranged on the second surface 171b in this preferred embodiment, the diffraction grating 172 may also be arranged on the first surface 171a, or may even cover both of the first and second surfaces 171a and 171b.

Also, even though the basic shape of the first and second surfaces 171a and 171b is an aspheric shape according to this preferred embodiment, the basic shape may also be a spherical shape or a plate shape. The first and second surfaces 171a and 171b may either have the same basic shape or mutually different basic shapes. Furthermore, the basic shape of the first and second surfaces 171a and 171b is a convex aspheric shape according to this preferred embodiment, but may also be a concave aspheric shape. Optionally, one of the first and second surfaces 171a and 171b may have a convex basic shape and the other a concave basic shape.

In this description, the “basic shape” refers to a designed surface shape of the lens body 171, which has not been patterned into the shape of the diffraction grating 172 yet. In other words, unless a structure such as the diffraction grating 172 is formed there, the surface of the lens body 171 keeps its basic shape. For example, since no diffraction grating has been formed on the first surface 171a according to this preferred embodiment, the basic shape of the first surface 171a is unchanged from its own surface shape that is an aspheric one.

The second surface 171b is defined by forming the diffraction grating 172 on the surface with the basic shape. Since the second surface 171b has the diffraction grating 172, the second surface 171b of the lens body 171 with the diffraction grating 172 no longer has an aspheric shape. However, since the diffraction grating 172 has a shape that is based on a predetermined condition as will be described later, the basic shape of the second surface 171b can be estimated based on the macroscopic shape of the second surface 171b with the diffraction grating 172. As the basic shape is just a designed shape, the lens body 171 with no diffraction grating 172 yet does not have to have a surface with that basic shape.

FIG. 2 illustrates, on a larger scale, a cross section of the diffraction grating lens 1 in the vicinity of the diffraction grating 172 as viewed on a plane including the optical axis 173 of the diffraction grating lens 1. As shown in FIGS. 1 and 2, the diffraction grating 172 has a number of diffraction steps 14 and a number of concentric annular zones 13, each of which is interposed between two adjacent ones of the multiple diffraction steps 14. In this preferred embodiment, the annular zones 13 are arranged concentrically with respect to the optical axis 173 of the aspheric basic shapes of the first and second surfaces 171a and 171b. That is to say, the optical axis of the diffraction grating 52 agrees with the optical axis 173 of the aspheric basic shape. And this optical axis 173 is the optical axis of the entire diffraction grating lens 1 as well. To improve the aberration property of an imaging optical system, the annular zones 13 preferably have a rotationally symmetric shape with respect to the optical axis 173.

As shown in FIG. 2, in this preferred embodiment, each annular zone 13 has an intermediate portion 13C and a pair of end portions 13E that interposes the intermediate portion 13C between them in the radial direction. In each annular zone 13, the inner end portion 13E has a recess 11 and the outer end portion 13E has a protrusion 12. Each of the recess 11 and the protrusion 12 is provided to form at least part of, and preferably all of, its associated inner or outer end portion 13E. These annular zones 13 form a saw-toothed cross section on the plane including the optical axis 173 of the diffraction grating lens 1. That is to say, the edge of each saw tooth is located on the inner end that is closer to the center of the diffraction grating lens 1, while the base of the saw tooth is located on the outer end. If the refractive index n₁ (λ) of the lens body 171 is greater than the refractive index n₂ (λ) of the medium that the diffraction grating 172 contacts with, then the diffraction grating 172 with such a shape condenses the incoming light using the first-order diffracted light.

The rest of each annular zone 13 other than the recess 11 and the protrusion 12, i.e., the intermediate portion 13C, is arranged so as to transform the light that has entered the diffraction grating lens 1 into light that has been condensed just as designed by using a diffracted light ray of a designed order as is done in the prior art. Specifically, the intermediate portion 13c of each annular zone has a shape that is determined by the phase function given by Equation (1). Also, the diffraction steps 14 are arranged every time the phase as defined with respect to the reference point (i.e., the center) becomes equal to 2π in the phase function represented by Equation (1).

As the recess 11 and the protrusion 12 are provided as shown in FIG. 2, the step length of each diffraction step (that is the difference in level between two adjacent annular zones 13 as measured along the optical axis 173) becomes shorter by the height of the recess 11 and the protrusion 12 as measured along the optical axis 173 than the step length that a diffraction step with no recess 11 or protrusion 12 would have. However, since the protrusion 12 and the recess 11 are respectively arranged at the base and at the edge of each diffraction step 14, it appears that the step length of the diffraction step 14 has just shortened. As shown in FIG. 2, in the diffraction grating lens 1, the distance between the respective intermediate portions 13c of two adjacent annular zones 13 as measured along the optical axis 173 is equal to the designed step length d.

If the designed step length d satisfies Equation (2) mentioned above in the entire operating wavelength range of the diffraction grating lens 1, then the diffraction grating lens 1 can achieve 100% diffraction efficiency irrespective of the wavelength. In Equation (2), m is a designed order (e.g., m=1 as for first-order diffracted light) and n₁ (λ) is the refractive index of a lens material that makes the lens body 171 at the operating wavelength λ. In an actual diffraction grating lens 1, however, even if the diffraction efficiency is not 100% but roughly 90% or more, reasonably good optical performance can be achieved. As a result of extensive research, the present inventors came to the conclusion that this condition is represented by the following Equation (3):

$$0.9 d \leq \frac{m \cdot λ}{{n}_{1} ( λ ) - 1} \leq 1.1 d \qquad ( 3 )$$

Since the recess 11 and protrusion 12 are provided for each annular zone 13, the diffraction grating lens 1 of this preferred embodiment can minimize the stripe flare. The reason will be described in detail below.

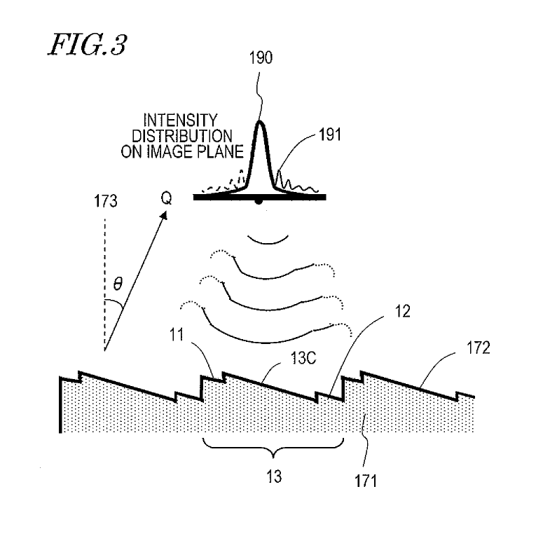

FIG. 3 is a cross-sectional view illustrating a portion of the diffraction grating lens 1 in the vicinity of the diffraction grating 172 as viewed on a plane including the optical axis of the diffraction grating lens 1. If the refractive index n₁ (λ) of the lens body 171 is greater than the refractive index n₂ (λ) of the medium that contacts with the diffraction grating 172, the light that is transmitted through the lens body 171 via a portion of each annular zone 13 that has a protrusion 12 in the diffraction grating 172 has its optical path length extended by the length of the protrusion 12. Conversely, in another portion of each annular zone 13 that has a recess 11, the light that is transmitted through the lens body 171 has its optical path length shortened by the length of the recess 11. As a result, in the light that has been transmitted through each annular zone 13, the wavefront of a light ray that has passed through the recess 11 that is located at the inner end portion 13E of the annular zone 13 is ahead of that of a light ray that has passed through the intermediate portion 13c of the annular zone 13. On the other hand, the wavefront of a light ray that has passed through the protrusion 12 that is located at the outer end portion 13E of the annular zone 13 is behind that of a light ray that has passed through the intermediate portion 13c of the annular zone 13.

The stripe flare 191 is produced by wavefront bypassing of the light that has been transmitted through a narrow annular zone of a diffraction grating. That is why due to a phase modulation such as a wavefront lag or lead that has been caused by the protrusion 12 and the recess 11, the wavefront traveling direction of the bypassed light changes at both ends of each annular zone. According to this preferred embodiment, the wavefront traveling direction of the bypassed light changes outward (i.e., in the direction indicated by the arrow Q) with respect to the traveling direction of light that passes through the intermediate portion 13c of an annular zone. On the other hand, the wavefront traveling direction of that light that is transmitted through, and gets diffracted by, the intermediate portion 13c of each annular zone 13 does not change.

FIG. 3 illustrates the wavefront of the light that is transmitted through the annular zone 13 parallel to the optical axis 173. However, the phase modulation is also caused by the protrusion 12 and the recess 11 when light that is not parallel to the optical axis 173 is transmitted through the annular zone 13. That is to say, according to this preferred embodiment, even when such light that is not parallel to the optical axis 173 is transmitted through the annular zone 13, the wavefront traveling direction of the light that has bypassed at both ends of the annular zone 13 also changes outward (i.e., in the direction indicated by the arrow Q) with respect to the traveling direction of the light that passes through the intermediate portion 13c of the annular zone 13.

As a result, the focus position of the stripe flare 191 on the image sensor shifts outward (i.e., toward the periphery of an image shot) and part of an image with the stripe flare 191 overlaps with an image 190 of the light source. Consequently, the integral quantity of light of the stripe flare that has been produced around the light source can be reduced. That is to say, the influence of the stripe flare on the image shot obtained can be cut down.

Particularly, in the diffraction grating lens 1 of this preferred embodiment, the recess 11 and protrusion 12 are respectively provided for the inner and outer end portions 13E of each annular zone 13, and therefore, the traveling direction of the stripe flare 191 can be changed significantly and the stripe flare 191 on an image shot can be reduced effectively. However, unless the shapes of those portions provided for the inner and outer end portions 13E of each annular zone 13 are opposite ones (i.e., if only recesses or protrusions are provided for both of the inner and outer end portions 13E), the wavefront phase modulations caused by the depressed or projected shapes would cancel each other and the wavefront traveling direction would also change much less significantly. Consequently, the effect of reducing the stripe flare 191 would diminish, too.

This effect of minimizing the stripe flare 191 by providing the recess 11 and the protrusion 12 can be achieved by changing the wavefront phase of the light that has been transmitted through both end portions 13E of the annular zone 13 and has bypassed. That is why it is preferred that the traveling direction of the light being transmitted through both of those end portions 13E be not changed significantly due to refraction caused by the surfaces that form the recess 11 and the protrusion 12. Specifically, the bottom of the recess 11 and the top of the protrusion 12 are preferably substantially parallel to the tilted surface of the intermediate portion 13C of the annular zone 13. This is because if the tilted surface of the intermediate portion 13C defined an angle of more than 10 degrees with respect to the bottom of the recess 11 and the top of the protrusion 12, then the traveling direction of the light being transmitted through both of the end portions 13E would change too much to achieve fully the effect of the present invention described above. On top of that, unnecessary stray light would also be produced and a different kind of flare than the stripe flare 191 could be produced, too.

To cause a phase modulation that is large enough to cut down the influence of the stripe flare 191 on an image shot, it is preferred that when measured perpendicularly to the optical axis of the diffraction grating 172 on the plane including that optical axis, the respective widths w1 and w2 of the recess 11 and the protrusion 12 be 5% or more of the width W of the annular zone 13. In this case, if the respective widths w1 and w2 of the recess 11 and the protrusion 12 are not constant when measured parallel to the optical axis, then the maximum widths of the recess 11 and protrusion 12 are defined to be their widths w1 and w2.

Meanwhile, such recesses 11 and protrusions 12 could be a factor in a decrease in a bundle of rays to be condensed at their original focus position through diffraction (i.e., a decline in diffraction power) and in the generation of an aberration. On top of that, the phase modulation caused by the recess 11 and the protrusion 12 will produce some components, of which the phases are ahead of, and behind, that of diffracted light that should contribute to condensing, and therefore, could disturb the wavelength dependence of diffraction efficiency and produce unnecessary order diffracted light. In order to avoid debasing the image quality due to such an aberration or unnecessary order diffracted light, it is preferred that when measured perpendicularly to the optical axis of the diffraction grating 172 on the plane including that optical axis, the respective widths w1 and w2 of the recess 11 and the protrusion 12 be 25% or less of the width W of the annular zone 13. Consequently, when measured perpendicularly to the optical axis of the diffraction grating 172 on the plane including that optical axis, the respective widths w1 and w2 of the recess 11 and the protrusion 12 preferably fall within the range of 5% to 25% of the width W of the annular zone 13.

Also, if the respective heights (or depths) d1 and d2 of the recess 11 and protrusion 12 as measured parallel to the optical axis were too small, then the phase difference would be too small to reduce the stripe flare 191 sufficiently. On the other hand, if those heights d1 and d2 were too large, then the diffraction power would decline and unnecessary order diffracted light 176 and aberration would be generated to debase the image quality as in the widths of the recess 11 and protrusion 12. For these reasons, the respective heights d1 and d2 of the recess 11 and protrusion preferably fall within the range of 3% to 20% of the designed step length d of the diffraction step. In this case, if the respective heights d1 and d2 of the recess 11 and the protrusion 12 are not constant when measured perpendicularly to the optical axis, then the maximum heights of the recess 11 and protrusion 12 are defined to be their heights d1 and d2 measured perpendicularly to the optical axis.

As long as they fall within the range defined above, the respective widths w1 and w2 of the recess 11 and protrusion 12 may be equal to each other or different from each other. Also, those widths w1 and w2 of the recess 11 and protrusion 12 may be the same in every annular zone 13 or may vary from one annular zone 13 to another. Likewise, the respective heights d1 and d2 of the recess 11 and protrusion 12 may be equal to each other or different from each other. Also, those heights d1 and d2 of the recess 11 and protrusion 12 may be the same in every annular zone 13 or may vary from one annular zone 13 to another.

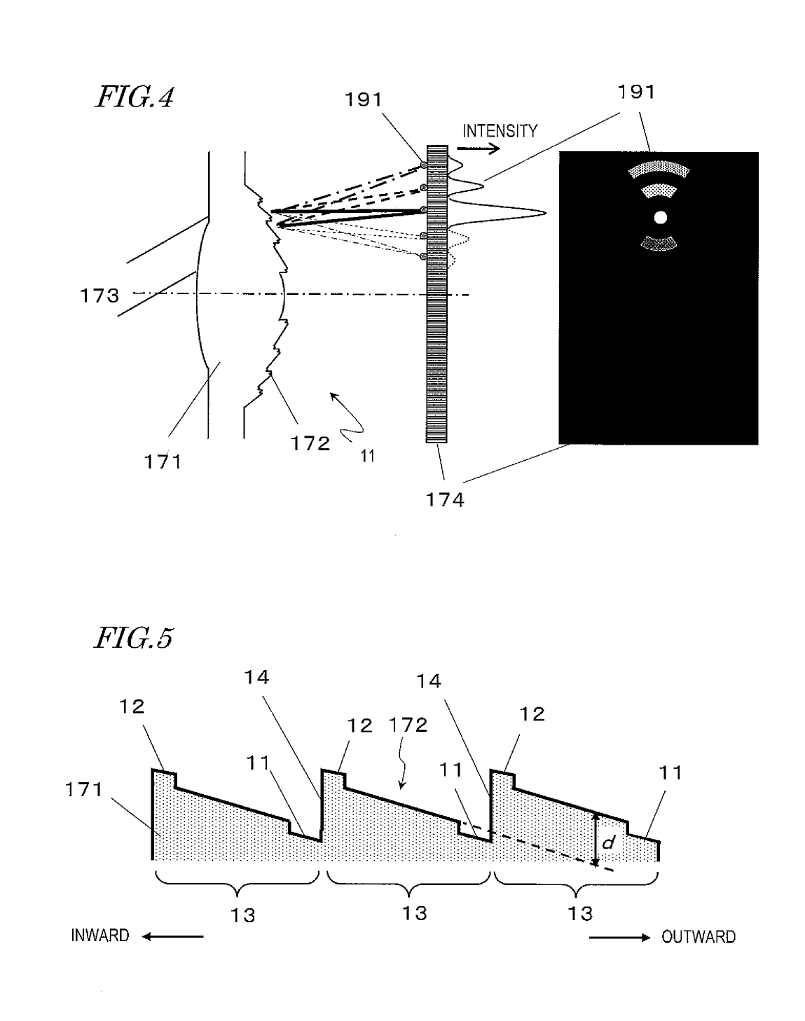

The present inventors carried out an image evaluation using an actual lens. As a result, we confirmed that when the recesses 11 and protrusions 12 were provided for the annular zones 13, the focus position of the stripe flare 191 shifted compared to a situation where no recesses 11 or protrusions 12 were provided. FIG. 4 schematically illustrates what stripe flare 191 was observed on an image that was shot by an image sensor 174 in a situation where the diffraction grating lens 1 was arranged so that the diffraction grating 172 was located as close to the image sensor as possible. As can be seen easily, compared to the distribution of the stripe flare 191 in the conventional imaging device shown in FIG. 24, if the diffraction grating lens 1 of this preferred embodiment is used when an intense light source is arranged so as to be captured in the peripheral area of the image, then the intensity of the stripe flare 191, which is located closer to the center of the image than the light source image is, will decrease. This is because the focus position of the stripe flare 191 shifts outward on the image capturing plane and a part of the image of the stripe flare overlaps with the light source image.

In the preferred embodiment described above, by arranging the recess 11 and the protrusion 12 at the inner and outer end portions 13E, respectively, in each annular zone 13, the location where the stripe flare 191 is produced is shifted toward the periphery of an image shot. In many applications of the diffraction grating lens 1 of this preferred embodiment, a more important piece of information is often included at the center of an image shot. That is why by shifting the stripe flare 191 to the periphery of the image shot, the deterioration of the image quality due to the stripe flare can be reduced. As a result, an image of quality can be obtained. Depending on the application, however, an important piece of information could be located closer to the periphery of an image shot with respect to the image of the light source being condensed by the diffraction grating lens 1, and therefore, the stripe flare should sometimes be shifted toward the center of the image shot. In that case, in the diffraction grating lens 1 shown in FIGS. 1 and 2, the recesses 11 and the protrusions 12 may change positions with each other.

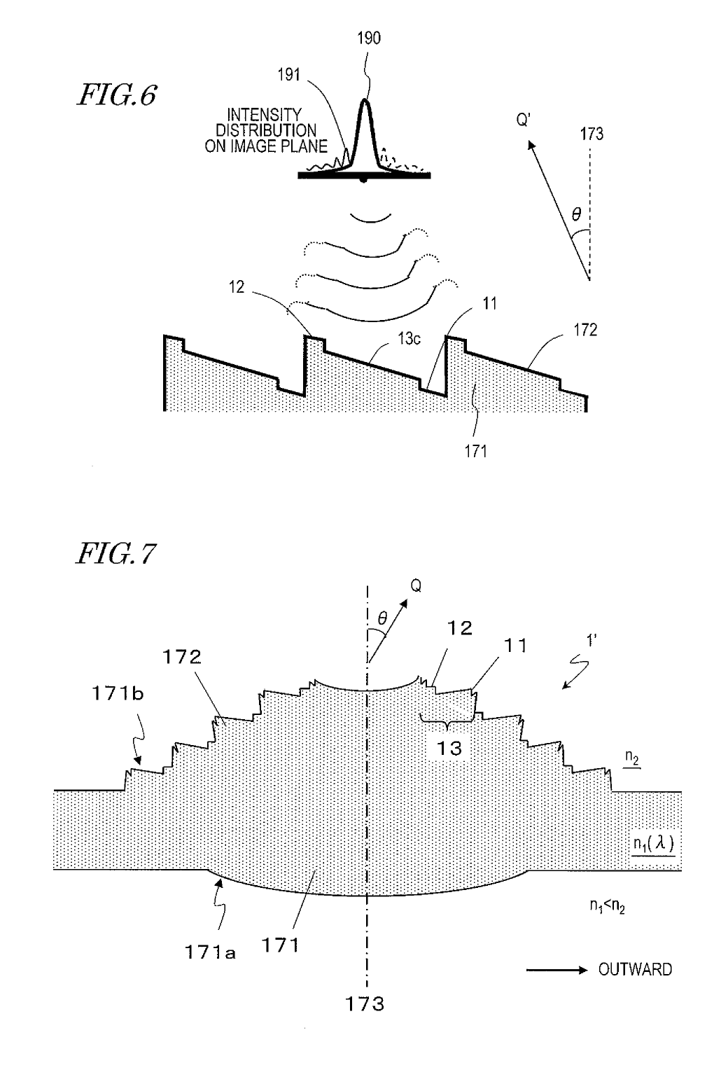

Specifically, in that case, the protrusion 12 and the recess 11 may be arranged at the inner and outer end portions 13E, respectively, in each annular zone 13 as shown in FIG. 5. As shown in FIG. 6, the light that is transmitted through the lens body 171 via a portion of each annular zone that has the protrusion 12 has its optical path length extended by the length of the protrusion 12. Conversely, in another portion of each annular zone 13 that has the recess 11, the light that is transmitted through the lens body 171 has its optical path length shortened by the length of the recess 11. As a result, in the light that has been transmitted through each annular zone 13, the wavefront of a light ray that has passed through the recess 11 that is located at the outer end portion 13E of the annular zone 13 is ahead of that of a light ray that has passed through the intermediate portion 13c of the annular zone 13. On the other hand, the wavefront of a light ray that has passed through the protrusion 12 that is located at the inner end portion 13E of the annular zone 13 is behind that of a light ray that has passed through the intermediate portion 13c of the annular zone 13. As a result, the wavefront traveling direction of the bypassed light changes at both ends of each annular zone 13. And the wavefront traveling direction of the bypassed light changes inward (i.e., in the direction indicated by the arrow Q′) with respect to the traveling direction of light that passes through the intermediate portion 13c of an annular zone. On the other hand, the wavefront traveling direction of that light that is transmitted through, and gets diffracted by, the intermediate portion 13c of each annular zone 13 does not change. Consequently, the focus position of the stripe flare 191 on the image sensor shifts inward (i.e., toward the center of the image shot) and a portion of the image of the stripe flare 191 overlaps with the image of the light source 190. As a result, the intensity of the stripe flare 191 can be reduced in the peripheral area on the image sensor.

Optionally, contrary to the preferred embodiment described above, the refractive index n₁ (λ) of the lens body 171 may be smaller than the refractive index n₂ (λ) of the medium that the diffraction grating 172 contacts with. The diffraction grating lens 1′ shown in FIG. 7 includes a lens body 171, of which the refractive index n1 (λ) is smaller than the refractive index n₂ (λ) of the medium. As will be described later with respect to a second preferred embodiment of the present invention, if the surface of the diffraction grating 172 is covered with an optical adjustment layer that has a greater refractive index than the refractive index n₁ (λ) of the lens body 171, the structure shown in FIG. 7 is preferably used.

As shown in FIG. 7, in this diffraction grating lens 1′, the annular zones 13 form a saw-toothed cross section on the plane including the optical axis 173 of the diffraction grating lens 1. That is to say, the base of each saw tooth is located on the inner end that is closer to the center of the diffraction grating lens 1, while the edge of the saw tooth is located on the outer end. If the refractive index n1 (λ) of the lens body is smaller than the refractive index n₂ (λ) of the medium that the diffraction grating 172 contacts with, then the diffraction grating 172 with such a shape condenses the incoming light using the first-order diffracted light. In each annular zone 13, the inner end portion 13E has a protrusion 12 and the outer end portion 13E has a recess 11.

In this diffraction grating lens 1′, the refractive index n₁ (λ) of the lens body is smaller than the refractive index n₂ (λ) of the medium that contacts with the diffraction grating 172. As a result, in the light that has been transmitted through each annular zone 13, the wavefront of a light ray that has passed through the protrusion 12 that is located at the inner end portion 13E of the annular zone 13 is ahead of that of a light ray that has passed through the intermediate portion 13c of the annular zone 13. On the other hand, the wavefront of a light ray that has passed through the recess 11 that is located at the outer end portion 13E of the annular zone 13 is behind that of a light ray that has passed through the intermediate portion 13c of the annular zone 13. As a result, the wavefront traveling direction of the bypassed light changes outward (i.e., in the direction indicated by the arrow Q) with respect to the traveling direction of light that passes through the intermediate portion 13c of an annular zone. As a result, the focus position of the stripe flare 191 on the image sensor shifts outward (i.e., toward the periphery of an image shot) and part of an image with the stripe flare 191 overlaps with an image 190 of the light source. Consequently, the integral quantity of light of the stripe flare that has been produced around the light source can be reduced. That is to say, the influence of the stripe flare on the image shot obtained can be cut down.

In the diffraction grating lens of the preferred embodiment described above, the recesses 11 and protrusions 12 provided for the annular zones are supposed to have a rectangular cross section on a plane including the optical axis. However, the recesses 11 and protrusions 12 may also have any other cross-sectional shape, not just the rectangular one.

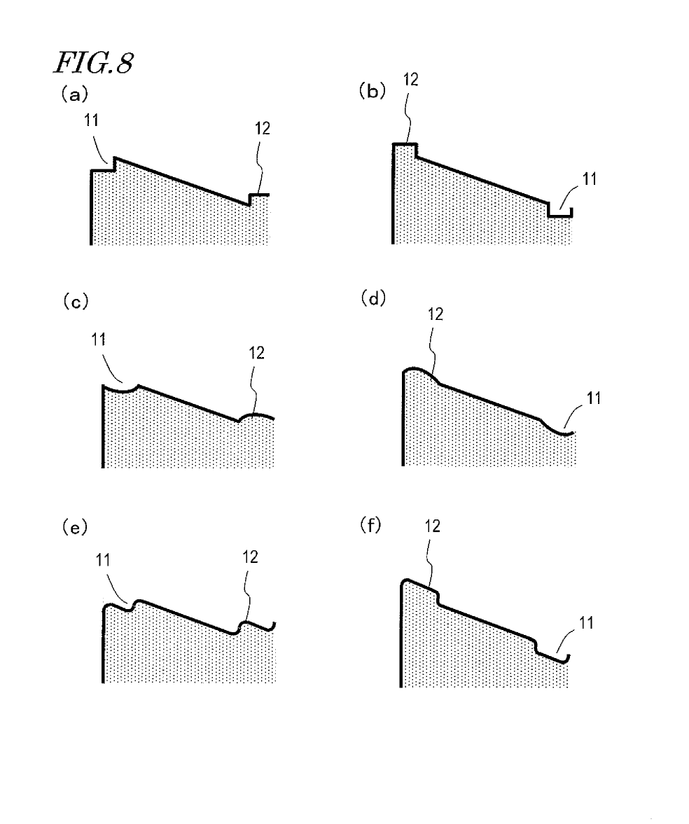

FIGS. 8(a) through 8(f) illustrate examples of the cross-sectional shapes that each annular zone 13 may have in the diffraction grating lens 1 of this preferred embodiment. As described above, the recess 11 and the protrusion 12 may naturally have a rectangular cross-sectional shape on a plane including the optical axis of the diffraction grating lens 1 as shown in FIGS. 8(a) and 8(b). Alternatively, the recess 11 may have a cross-sectional shape with a concave arced bottom and the protrusion 12 may have a cross-sectional shape with a convex arced top as shown in FIGS. 8(c) and 8(d). Still alternatively, the recess 11 and the protrusion 12 may even have a rectangular cross-sectional shape with rounded corners as shown in FIGS. 8(e) and 8(f). In any of these cases, however, the principal surface that forms the bottom of the recess 11 and the top of the protrusion 12 preferably defines an angle of 10 degrees or less with respect to the tilted surface of the intermediate portion 13C for the reasons mentioned above.

Furthermore, although the recess 11 and protrusion 12 are supposed to be provided for every annular zone in the preferred embodiment described above, the influence of the stripe flare on only a target location on an image shot may be reduced just locally by providing the recesses 11 and protrusions 12 for at least two of the annular zones. For example, if the stripe flare should be reduced particularly significantly in a peripheral portion of an image shot, the stripe flare can be reduced in a particular direction on the image shot by providing the recesses 11 and protrusions 12 for only some of the inner and outer end portions E of the annular zones outside of the center of the effective area Ae of the lens body shown in FIG. 1 as defined in the radial direction of the diffraction grating. Meanwhile, if light is incident on only a part of the diffraction grating of the diffraction grating lens through a diaphragm, for example (i.e., if only a part of the area with the diffraction grating is an effective area), then the recesses 11 and protrusions 12 just need to be provided for the annular zones that fall within that effective area.

As can be seen from the foregoing description, in the diffraction grating lens of the preferred embodiment described above, one of a recess and a protrusion is provided for the inner end portion of an annular zone and the other is provided for the outer end portion of the annular zone. That is why a location where stripe flare will be produced can be shifted. As a result, on an image shot, part of the stripe flare and an image of the light source can overlap with each other. Or on an image capturing plane, the focus position of a part of the stripe flare can be shifted outward. Consequently, the integral quantity of stripe flare to be produced around the light source can be reduced and the influence of the stripe flare on the image shot can be cut down as well.

### Embodiment 2

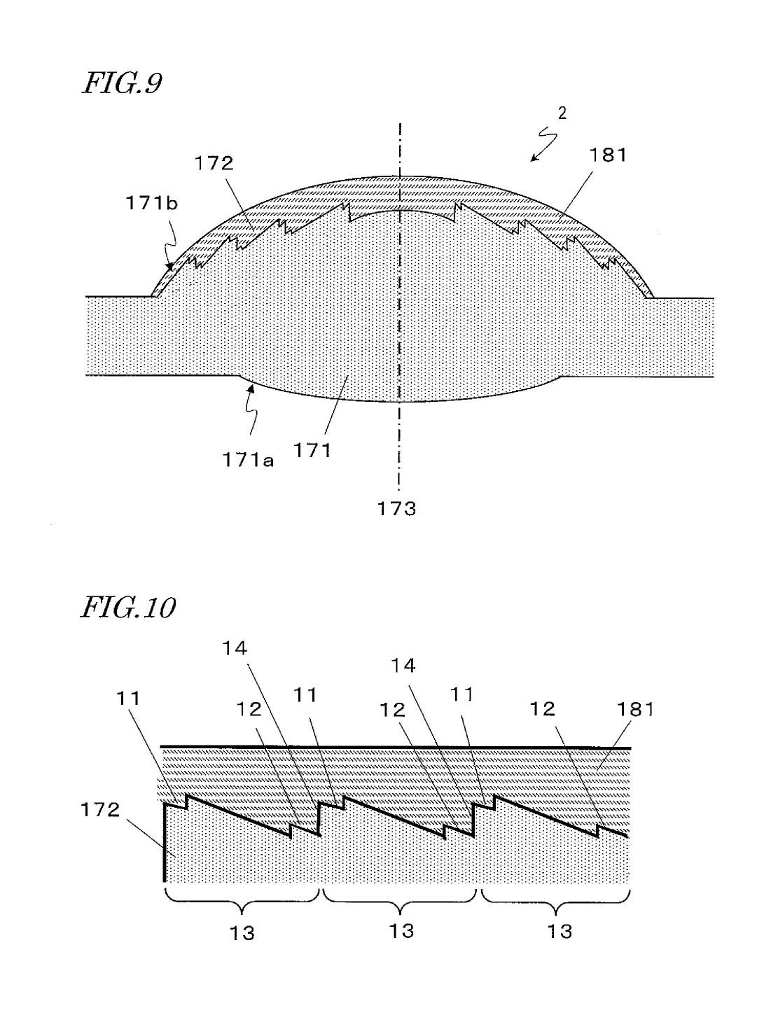

Hereinafter, a second preferred embodiment of a diffraction grating lens according to the present invention will be described. FIG. 9 is a cross-sectional view illustrating the structure of a diffraction grating lens 2 as a second preferred embodiment of the present invention. The diffraction grating lens 2 includes a lens body 171, a diffraction grating 172 that has been formed on the surface of the lens body 171, and an optical adjustment layer 181, which has been provided for the lens body 171 to cover the diffraction grating 172.

FIG. 10 illustrates, on a larger scale, a cross section of a portion of the diffraction grating lens 2 in the vicinity of the diffraction grating 172 as viewed on a plane that passes through the optical axis 173 of the diffraction grating lens 2. The lens body 171 and the diffraction grating 172 have the same structure as what has already been described for the first preferred embodiment. Specifically, as in the first preferred embodiment, the lens body 1 is made of a first material that has a refractive index n₁ (λ) at the operating wavelength λ. The diffraction grating 172 is made up of a number of diffraction steps 14, and a number of concentric annular zones 13, each of which is interposed between two adjacent ones of the diffraction steps 14. In each annular zone 13, a recess 11 is provided for the inner end portion 13E and a protrusion 12 is provided for the outer end portion 13E.

The optical adjustment layer 181 is made of a second material that has a refractive index n₂ (λ) at the operating wavelength λ and covers the diffraction grating 172 so as to fill at least the diffraction steps 14 and the recesses 11 of the inner end portions 13E as shown in FIG.

10.

In the diffraction grating lens 2 shown in FIG. 9, the refractive index n₁ (λ) of the lens body 171 is greater than the refractive index n₂ (λ) of the optical adjustment layer 181. Also, as in the diffraction grating lens 1 shown in FIG. 1, these annular zones 13 form a saw-toothed cross section on the plane including the optical axis 173 of the diffraction grating lens 2. That is to say, the edge of each saw tooth is located on the inner end that is closer to the center of the diffraction grating lens 2, while the base of the saw tooth is located on the outer end. Thus, the diffraction grating 172 with such a shape condenses the incoming light using the first-order diffracted light.

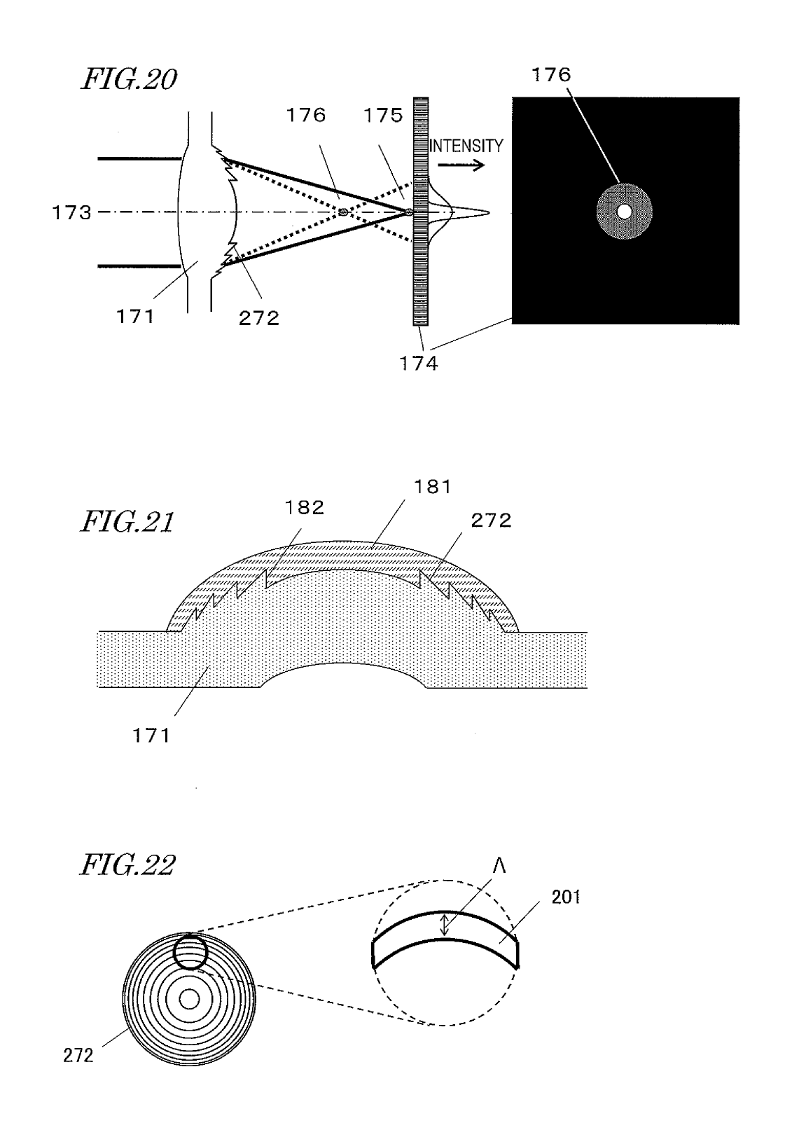

In an ordinary diffraction grating lens, the medium that the diffraction grating contacts with is the air. In this case, the unnecessary order diffracted light 176 that has already been described with reference to FIG. 20 is produced. Under an intense light source, the stripe flare 191 produced is much more noticeable than the unnecessary order diffracted light 176. That is why with the diffraction grating lens 1 that has the structure of the first preferred embodiment described above, the quality of an image shot can be improved sufficiently by minimizing the stripe flare 191. Nevertheless, in order to obtain an optical system that can generate an image of even better quality, not just the stripe flare 191 but also the unnecessary order diffracted light 176 are preferably removed as well. For that reason, this diffraction grating lens 2 includes an optical adjustment layer 181 that has such a refractive index-wavelength characteristic that can reduce the wavelength dependence of the diffraction efficiency. The condition to be satisfied by the diffraction steps of the diffraction grating lens 2 is equivalent to what is obtained by replacing the refractive index of the air (that is one) with that of the optical adjustment layer 181. Specifically, supposing m represents the order of diffraction, the designed step length d, the refractive index n₁ (λ) of the lens body 171 and the refractive index n₂ (λ) of the optical adjustment layer 181 satisfy the following inequality:

$$0.9 d \leq \frac{m \cdot λ}{{n}_{1} ( λ ) - {n}_{2} ( λ )} \leq 1.1 d \qquad ( 4 )$$

This inequality means that if the refractive index n₂ (λ) is greater than the refractive index n₁ (λ), then the inverse number of the phase difference is added to the basic shape.

In the diffraction grating lens 2 of this preferred embodiment, the designed step length d of the diffraction steps tends to increase compared to the diffraction grating lens 1 of the first preferred embodiment described above. As a result, in order to reduce the stripe flare 191, the recess 11 and the protrusion 12 should be higher than in the first preferred embodiment described above. Consequently, the recesses 11 and the protrusions 12 can be formed more easily and the stripe flare 191 can be reduced more effectively.

In the diffraction grating lens 2 shown in FIG. 9, the refractive index n₁ (λ) of the lens body 171 is greater than the refractive index n₂ (λ) of the optical adjustment layer 181. However, the magnitudes of refractive indices of these two members may be reversed. In that case (i.e., if the refractive index n₁ (λ) of the lens body 171 is smaller than the refractive index n₂ (λ) of the optical adjustment layer 181), then the lens body 171 will have a shape as shown in FIG. 7 in which the base of a saw tooth is located on the inner end closer to the center of the diffraction grating lens 1 and the edge of the saw tooth is located on the outer end. And such a lens body 171 will be covered with the optical adjustment layer 181.

### Embodiment 3

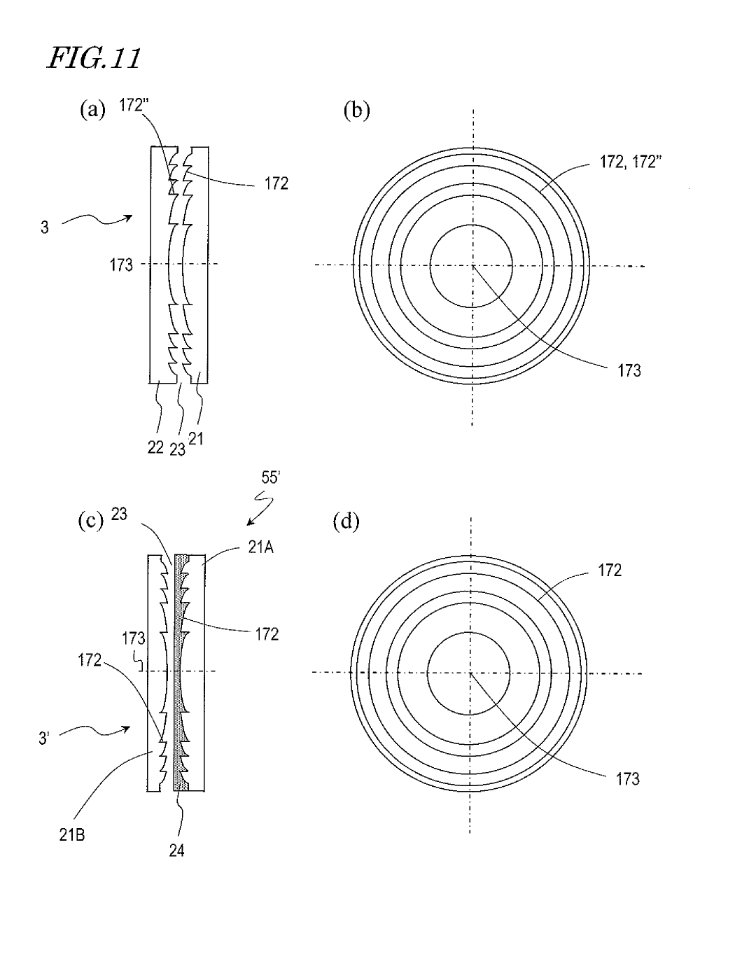

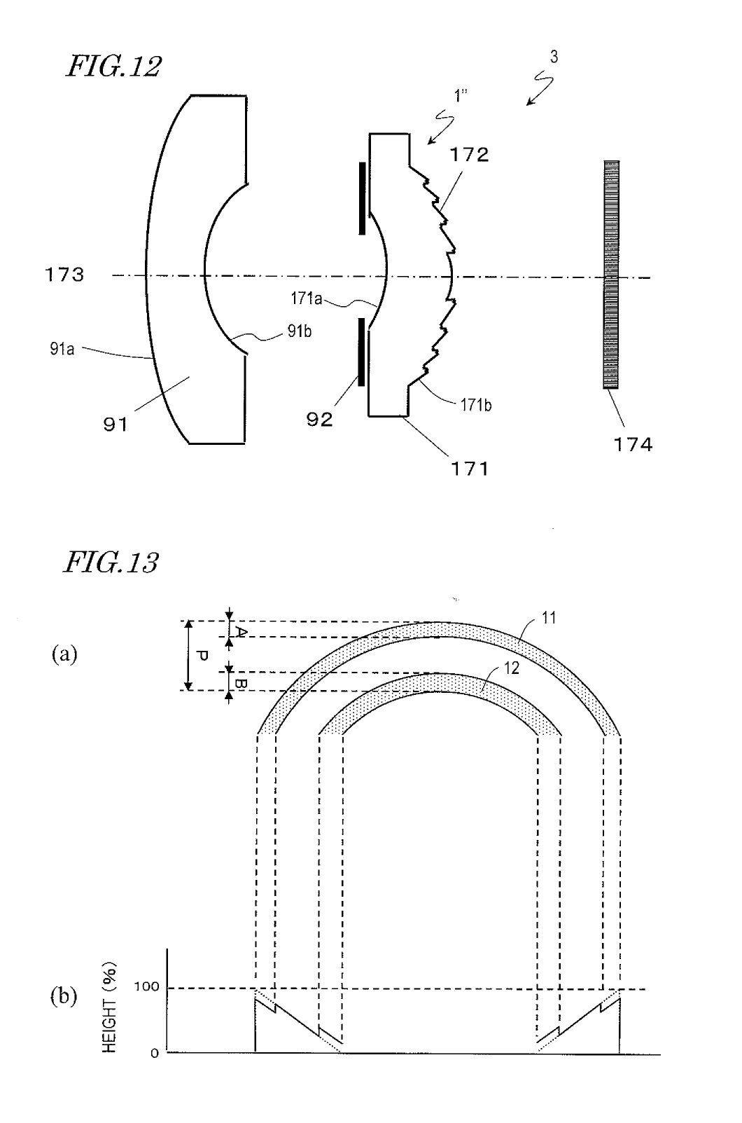

Next, a preferred embodiment of an optical element according to the present invention will be described. FIGS. 11(a) and 11(b) are respectively a schematic cross-sectional view and a plan view illustrating a preferred embodiment of an optical element according to the present invention. This optical element 3 includes two diffraction grating lenses 21 and 22. The diffraction grating lens 21 may be the diffraction grating lens 1 of the first preferred embodiment, for example, and has a diffraction grating 172 with the structure that has already been described for the first preferred embodiment. On the other hand, the diffraction grating lens 22 has a diffraction grating 172 having the structure of the first preferred embodiment shown in FIG. 7. These two diffraction grating lenses 21 and 22 are held with a predetermined gap 23 left between them.

FIGS. 11(c) and 11(d) are respectively a schematic cross-sectional view and a plan view illustrating another preferred embodiment of an optical element according to the present invention. This optical element 3′ includes two diffraction grating lenses 21A and 21B and an optical adjustment layer 24. Specifically, a diffraction grating 172 with the structure that has already been described for the first preferred embodiment has been formed on one surface of the diffraction grating lens 21A. A diffraction grating 172 has also been formed on the other diffraction grating lens 21B. The optical adjustment layer 24 covers the diffraction grating 172 of the diffraction grating lens 21A. These two diffraction grating lenses 21A and 21B are held with a predetermined gap 23 left between the diffraction grating 172 on the surface of the diffraction grating lens 21B and the optical adjustment layer 24.

Even such an optical element 3, 3′ in which two diffraction grating lenses are stacked one upon the other can also minimize the influence of the stripe flare because its diffraction grating 172 has the structure that has already been described for the first preferred embodiment.

### Embodiment 4

Next, a preferred embodiment of an imaging device according to the present invention will be described. FIG. 12 is a schematic cross-sectional view illustrating the arrangement of an imaging device 4 as a fourth specific preferred embodiment of the present invention. This imaging device 4 includes a lens 91, a diffraction grating lens 1″, a diaphragm 92 and an image sensor 174. The imaging device 4 of this preferred embodiment has not only the diffraction grating lens 1″ but also the additional lens 91. However, the number of the lenses (including the diffraction grating lens 1″) for use in this imaging device 4 does not have to be two. Thus, the imaging device 4 may have only one lens or three or more lenses as well. If the number of lenses to use is increased, the optical performance can be improved. Also, the basic shape of the lens 91 and the diffraction grating lens 1″ may be spherical or aspheric.

The diffraction grating lens 1″ has the same structure as the diffraction grating lens 1 of the first preferred embodiment except that the basic shape of the first surface 171a is a concave one.

If the imaging optical system has multiple lenses, the diffraction grating 172 may be provided for any of those lenses. Also, the surface with the diffraction grating 172 may be arranged closer to either the subject or the image. Or diffraction gratings 172 may even be arranged on multiple surfaces, too. Furthermore, the annular zones of the diffraction grating 172 are preferably arranged rotationally symmetrically with respect to the optical axis 173 in order to improve the aberration property of the imaging optical system.

Although the diaphragm 92 is arranged between the lens 91 and the diffraction grating lens 1″ according to this preferred embodiment, the diaphragm 92 may also be arranged at any other position, which is determined through an optical design process. If the diaphragm 92 is arranged closer to the image than the diffraction grating lens 1″ is and if the effective area to pass light rays covers the entire diffraction grating 172, then the light will be transmitted through the whole annular zones. For that reason, the recesses 11 and the protrusions 12 are preferably formed all around the annular zones in that case.

On the other hand, if the diaphragm 92 is arranged closer to the subject than the diffraction grating 172 is, then the effective area at the angle of view that is limited by the diaphragm 92 will form part of the annular zones. In that case, the recesses 11 and the protrusions 12 may be arranged within the effective area of the annular zones.

It should be noted that the stripe flare may or may not be produced depending on where the lens surface with the diffraction grating is arranged in the imaging optical system, how many annular zones the diffraction grating has, how much the diffraction step length d is, where the diaphragm is arranged, what phase relation the diffractive surface has, and other factors. The shapes of those recesses 11 and protrusions 12 and the arrangement of the annular zones with those recesses 11 and protrusions 12 may be determined appropriately with these factors taken into account.

The imaging device of this preferred embodiment can reduce the influence of the stripe flare 191 on the area surrounding an image so significantly that the device can be used particularly effectively when an image needs to be shot at a wide angle.

### Embodiment 5

Next, a preferred embodiment of a method of making a diffraction grating lens according to the present invention will be described.

First of all, a diffraction grating lens is made so that a recess 11 and a protrusion 12 are provided for at least one of its annular zones.

If the lens body 171 needs to be made by a molding process, then the molding die to use may define in advance not only the annular zone shape but also the shapes of the recesses 11 and protrusions 12. Then, when the lens body 171 with the annular zone shape is formed, the recesses 11 and protrusions 12 can also be formed on the annular zones at the same time. In this case, the recesses 11 and protrusions 12 can be formed on the molding die by a cutting process using a diamond cutter, a grinding process using a whetstone, an etching process, or a transfer process from a master. Examples of preferred molding processes include an injection molding process, a press molding process, and a cast molding process.

With such a manufacturing process adopted, there is no need to form recesses 11 and protrusions 12 for each diffraction grating lens separately, but not only the annular zone shape but also the recesses 11 and protrusions 12 can be formed at the same time so that all of them form integral parts of the lens. As a result, a very high degree of productivity can be achieved. Examples of materials for the lens body 171 include a thermoplastic resin, a thermosetting resin, an energy ray curable resin, low temperature molding glass, and various other resins and glass materials. Any appropriate one of these materials may be selected to make the lens body according to the intended application.

If the lens body 171 is made by performing either a cutting process or a grinding process, the shapes of the recesses 11 and protrusions 12 may be formed when the annular zone shape is formed by cutting. In that case, considering how easy it will be to form it into an intended shape, it is particularly preferred that a thermoplastic resin such as polycarbonate, alicyclic olefin resin or PMMA be used.

Optionally, after the lens body 171 with the annular zone shape has been formed by molding, for example, recesses 11 may be formed on the annular zones by etching, laser beam direct drawing, or electron beam drawing, and then protrusions 12 may be formed thereon by applying the material of the lens body 171 to the annular zone shape through coating or printing. Still alternatively, the entire lens body 171 that has the annular zone shape with the recesses 11 and protrusions 12 may be formed by rapid prototyping, for example.

In some cases, the recesses 11 and protrusions 12 that have been formed on the annular zone by any of these methods may have some radius of curvature due to the shape of the tool that has been used in the molding or cutting process. However, this should not be a serious problem as long as the image quality of an image shot is not debased by the curvature. The diffraction grating lens of the first preferred embodiment described above may be made by performing such a method.

To make the diffraction grating lens of the second preferred embodiment, on the other hand, it is necessary to perform the process step of forming an optical adjustment layer 181 to cover the diffraction grating 172 of the diffraction grating lens that has been formed by the method described above.

As already described for the second preferred embodiment, the diffraction grating lens of the second preferred embodiment has a greater diffraction step length d than the counterpart of the first preferred embodiment. That is why according to the second preferred embodiment, the recesses 11 and protrusions 12 come to have an increased height and can be formed more easily by either molding or cutting, and therefore, lenses can be manufactured efficiently with the influence of the stripe flare 191 reduced effectively.

Any material may be used to make the optical adjustment layer 181 as long as the material has a refractive index characteristic that satisfies Equation (4) and sufficiently high light ray transmittance, can fill the annular zones and their recesses and protrusions with no gaps left, and can form a surface shape that would not deteriorate the lens property. Examples of such materials include resins, glass, transparent ceramics, composite materials in which inorganic particles are dispersed in a resin, and hybrid materials including both organic and inorganic components. Considering how easy it will be to form the surface shape of the optical adjustment layer 181 in that case, it is particularly preferred to use a resin, a composite material or a hybrid material.

As for the method of forming the optical adjustment layer 181, any appropriate method may be selected according to the constituent material of the optical adjustment layer 181 and the surface shape precision required from among molding and application, coating, or the like, e.g., screen printing, pad printing, and ink jet technique. Alternatively, the optical adjustment layer 18 may also be formed by adopting two or more of these processes in combination.

Optionally, if necessary, a coating layer may be further provided on the surface of the diffraction grating lens of the second or first preferred embodiment thus formed. Examples of such coating layers include an antireflective layer, a hard coat layer, a UV cut layer, an infrared cut layer and other wavelength selecting layers.

### Example 1

Portion (a) of FIG. 13 is a partial plan view illustrating one annular zone of a diffraction grating lens as a first specific example of the present invention when viewed in the optical axis direction. A diaphragm is arranged away from the surface of the diffraction grating and the effective area of the diffraction grating surface forms part of the annular zone. That is why just a part of the annular zone in the effective area is shown in portion (a) of FIG. 13. In the diffraction grating lens of this specific example, a recess 11 and a protrusion 12 are arranged in the outer and inner end portions 13E, respectively, in each annular zone. Portion (b) of FIG. 13 shows the profile of the annular zone in the height direction where the designed diffraction step length d defined by Equation (4) is supposed to be 100%. The minimum pitch P of the annular zones is supposed to be 18 μm, the respective widths A and B of the recess 11 and protrusion 12 are supposed to be both 3 μm, and the respective heights of the recess 11 and protrusion 12 are supposed to be 10% of the diffraction step length d.

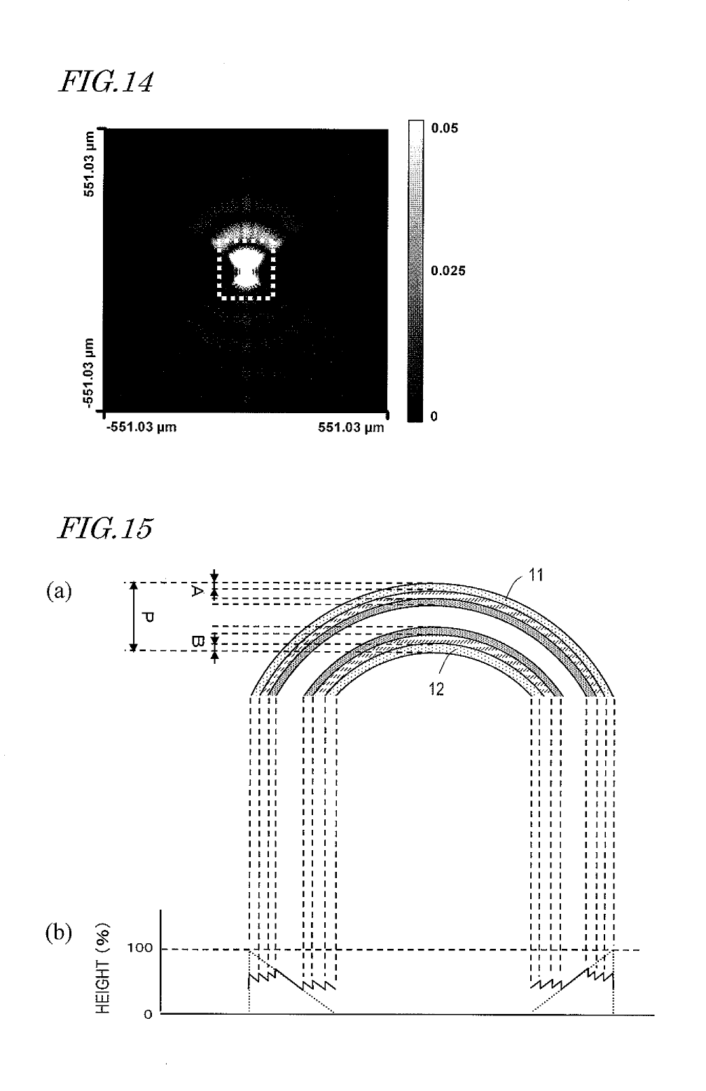

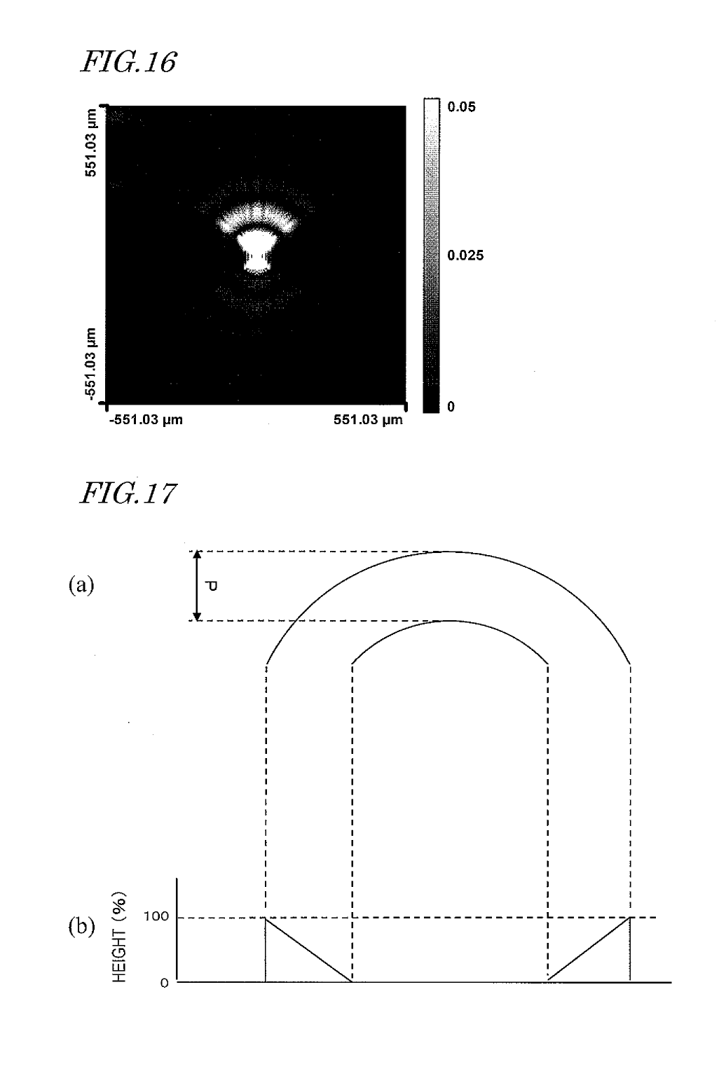

FIG. 14 illustrates an image that was shot by getting the light that had been condensed by the diffraction grating lens of this specific example detected by an image sensor. In FIG. 14, the intermediate portion surrounded with the dotted white frame represents the main light and the light produced outside of that dotted white frame represents the stripe flare 191. It can be seen that the position of the stripe flare 191 produced has shifted in FIG. 14 compared to the comparative example to be described later. This is an effect achieved by arranging the recess 11 and protrusion 12 at the edge of an annular zone and at the boundary between that and adjacent annular zones, respectively.

Using the diffraction grating lens of this specific example, the present inventors carried out a quantitative evaluation on the stripe flare 191. The diffraction grating lens was formed by an injection molding process using bisphenol A polycarbonate (with a d-line refractive index of 1.585 and an Abbe number of 27.9) and recesses 11 and protrusions 12 were formed at the same time all around every annular zone. The designed diffraction step length d was set to be 15 μm and the heights of the recesses 11 and protrusions 12 were both set to be 1.5 μm. And then an optical adjustment layer, made of a composite material in which particles of zirconium oxide (with a mean particle size of 5 nm) were dispersed in an acrylate based UV curable resin and which had a d-line refractive index of 1.623 and an Abbe number of 40, was formed to cover those recesses 11 and protrusions 12. A camera with the diffraction grating lens of this specific example was set up in a darkroom and a halogen lamp was arranged in a direction with a half angle of view of 60 degrees. And based on a halogen lamp image that was shot with the camera, the integral luminance of the stripe flare 191 that had been produced in an surrounding area was calculated.

As a result of the calculation, the present inventors confirmed that by using the diffraction grating lens of this specific example, the integral luminance of the stripe flare 191 could be cut down by 63% compared to the situation where the diffraction grating lens of Comparative Example 1 to be described later was used.

### Example 2

Portion (a) of FIG. 15 is a partial plan view illustrating one annular zone of a diffraction grating lens as a second specific example of the present invention when viewed in the optical axis direction. A diaphragm is arranged away from the surface of the diffraction grating. As in the first specific example of the present invention described above, a diaphragm is arranged away from the surface of the diffraction grating and the effective area of the diffraction grating surface forms part of the annular zone. That is why just a part of the annular zone in the effective area is shown in portion (a) of FIG. 15, too. In the diffraction grating lens of this specific example, a recess 11 and a protrusion 12 are arranged in the outer and inner end portions 13E, respectively, in each annular zone. Portion (b) of FIG. 13 shows the profile of the annular zone in the height direction where the designed diffraction step length d defined by Equation (4) is supposed to be 100%. The minimum pitch P of the annular zones is supposed to be 18 μm, the respective widths A and B of the recess 11 and protrusion 12 are supposed to be 1.5 μm, and the respective heights of the recess 11 and protrusion 12 are supposed to be 5% of the diffraction step length d.

FIG. 16 illustrates an image that was shot by getting the light that had been condensed by the diffraction grating lens of this specific example detected by an image sensor. In FIG. 16, the intermediate portion surrounded with the dotted white frame represents the main light and the light produced outside of that dotted white frame represents the stripe flare 191. It can be seen that as in the first specific example described above, the position of the stripe flare 191 produced has also shifted in FIG. 16 compared to the comparative example to be described later. As a result, the stripe flare 191 could be reduced as much as in the first specific example.

### Comparative Example

Portion (a) of FIG. 17 is a partial plan view illustrating one annular zone of a diffraction grating lens as a comparative example when viewed in the optical axis direction. A diaphragm is arranged away from the surface of the diffraction grating. As in the first specific example of the present invention described above, a diaphragm is arranged away from the surface of the diffraction grating and the effective area of the diffraction grating surface forms part of the annular zone. That is why just a part of the annular zone in the effective area is shown in portion (a) of FIG. 17. In the diffraction grating lens of this comparative example, the annular zones have the same basic shape, and the phase function used is also the same, as in the first specific example, but no recesses 11 or protrusions 12 are provided at all.

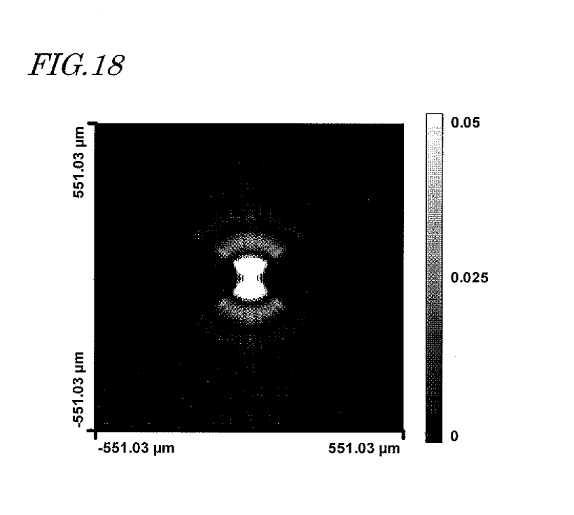

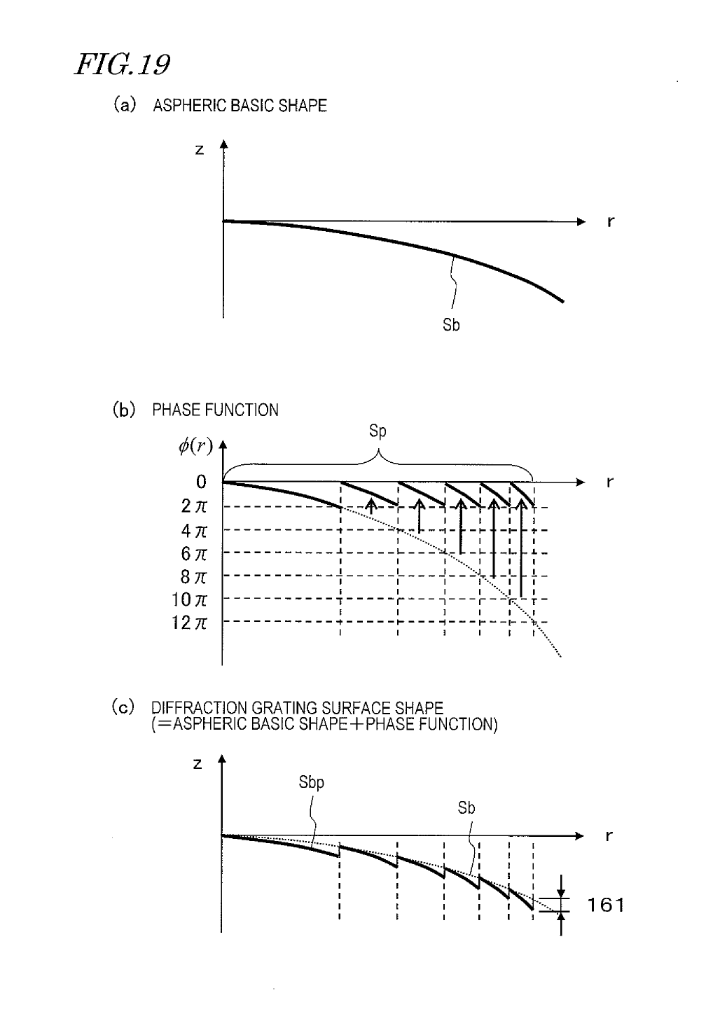

FIG. 18 illustrates an image that was shot by getting the light that had been condensed by the diffraction grating lens of this comparative example detected by an image sensor. In FIG. 18, the intermediate portion surrounded with the dotted white frame represents the main light and the light produced outside of that dotted white frame represents the stripe flare 191. It can be seen from FIG. 18 that the stripe flare 191 was produced horizontally symmetrically with respect to the original focus position.

Using the diffraction grating lens of this comparative example, the present inventors carried out an evaluation on the stripe flare 191 in the same way as in the first specific example. As a result, stripe flare 191 was produced close to the center of the image with respect to the intended focus position of the halogen lamp image.

### INDUSTRIAL APPLICABILITY

A diffraction grating lens according to the present invention and an imaging device that uses such a lens have the ability to reduce stripe flare, and therefore, can be used particularly effectively in a camera of high grade. Specifically, the diffraction grating lens and imaging device of the present invention can be used in digital cameras, cameras to be built in cellphones, automobile cameras, surveillance cameras, medical cameras, distance measurement sensors, and motion sensors, to name just a few.

### REFERENCE SIGNS LIST

11 recess

12 protrusion

13, 201 annular zone

14 diffraction step

91 lens

92 diaphragm

171 lens body

172 diffraction grating

173 optical axis

174 image sensor

175 first-order diffracted light

176 unnecessary order diffracted light

181 optical adjustment layer

191 stripe flare

211 wavefront bypassing

1. A diffraction grating lens comprising
a lens body, and
a diffraction grating which has been formed on the surface of the lens body and which includes a plurality of diffraction steps and a plurality of concentric annular zones, each said annular zone being interposed between two adjacent ones of the diffraction steps,
wherein the lens body is made of a first material that has a refractive index n₁ (λ) at an operating wavelength λ, and
wherein the diffraction grating is in contact with the air, and
wherein each said annular zone includes an intermediate portion and two end portions, between which the intermediate portion is interposed in a radial direction, at least one of the annular zones having a recess and a protrusion provided for at least a part of one of the two end portions thereof and at least a part of the other end portion thereof, respectively, and
wherein the diffraction grating lens satisfies the relation
$$0.9 d \leq \frac{m \cdot λ}{{n}_{1} ( λ ) - 1} \leq 1.1 d$$
where d represents a designed step length of the diffraction step and m represents an order of diffraction, and
wherein the intermediate portion of each of the annular zones has its shape determined by the phase function:
$$φ ( r ) = \frac{2 π}{{λ}_{0}} ψ ( r )$$
$$ψ ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + … + {a}_{i} {r}^{i} . \\ ( {r}^{2} = {x}^{2} + {y}^{2} )$$

2. A diffraction grating lens comprising
a lens body,
a diffraction grating which has been formed on the surface of the lens body and which includes a plurality of concentric diffraction steps and a plurality of concentric annular zones, each said annular zone being interposed between two adjacent ones of the diffraction steps, and
an optical adjustment layer, which is provided for the lens body so as to cover the diffraction grating,
wherein the lens body is made of a first material that has a refractive index n₁ (λ) at an operating wavelength λ, and
wherein the optical adjustment layer is made of a second material that has a refractive index n₂ (λ) at the operating wavelength λ, and
wherein each said annular zone includes an intermediate portion and two end portions, between which the intermediate portion is interposed in a radial direction, at least one of the annular zones having a recess and a protrusion provided for at least a part of one of the two end portions thereof and at least a part of the other end portion thereof, respectively, and
wherein the diffraction grating lens satisfies the relation
$$0.9 d \leq \frac{m \cdot λ}{{n}_{1} ( λ ) - {n}_{2} ( λ )} \leq 1.1 d$$
where d represents a designed step length of the diffraction step and m represents an order of diffraction, and
wherein the intermediate portion of each of the annular zones has its shape determined by the phase function:
$$φ ( r ) = \frac{2 π}{{λ}_{0}} ψ ( r )$$
$$ψ ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + … + {a}_{i} {r}^{i} . \\ ( {r}^{2} = {x}^{2} + {y}^{2} )$$

3. The diffraction grating lens of claim 1, wherein at least one of the protrusion and the recess is provided almost all around the at least one annular zone.

4. The diffraction grating lens of claim 3, wherein when measured perpendicularly to the optical axis of the diffraction grating on a plane that includes that optical axis, the width of the protrusion and the recess is within the range of 5% to 25% of the width of the at least one annular zone.

5. The diffraction grating lens of claim 4, wherein the height of the protrusion and the recess as measured along the optical axis of the diffraction grating is within the range of 3% to 20% of the designed step length d of the diffraction step.

6. The diffraction grating lens of claim 5, wherein the protrusion and the recess are provided for multiple ones of the annular zones.

7. The diffraction grating lens of claim 6, wherein the protrusion and the recess are provided for at least two of the multiple annular zones that are located around the outer periphery of the diffraction grating.

8. An imaging device comprising
the diffraction grating lens of claim 1, and
an image sensor.

9. The diffraction grating lens of claim 2, wherein at least one of the protrusion and the recess is provided almost all around the at least one annular zone.

10. The diffraction grating lens of claim 9, wherein when measured perpendicularly to the optical axis of the diffraction grating on a plane that includes that optical axis, the width of the protrusion and the recess is within the range of 5% to 25% of the width of the at least one annular zone.

11. The diffraction grating lens of claim 10, wherein the height of the protrusion and the recess as measured along the optical axis of the diffraction grating is within the range of 3% to 20% of the designed step length d of the diffraction step.

12. The diffraction grating lens of claim 11, wherein the protrusion and the recess are provided for multiple ones of the annular zones.

13. The diffraction grating lens of claim 12, wherein the protrusion and the recess are provided for at least two of the multiple annular zones that are located around the outer periphery of the diffraction grating.

14. An imaging device comprising
the diffraction grating lens of claim 2, and
an image sensor.
